(19) United States
(12) Patent Application Publication
(10) Pub. No.: US 2010/0094462 A1
(43) Pub. Date: Apr. 15, 2010

(54) Robot Control System

(76) Inventors: Hisayoshi Sugihara, Aichi-ken (JP); Yutaka Nonomura, Aichi-ken (JP); Motohiro Fujiyoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/989,606

(22) PCT Filed: Aug. 1, 2006
(86) PCT No.: PCT/IB2006/002097

§ 371 Date: Jan. 29, 2008

(30) Foreign Application Priority Data
Aug. 1, 2005 (JP) 2005-223512

(51) Int. Cl. B25J 9/00

(52) U.S. Cl. 700/258

(57) ABSTRACT

Communication is performed between a sensor unit (10) and a robot CPU (12) by using a serial data line (14). A variable length data format includes a transfer size section, a command section, a transfer pattern section, a measurement data section, and a CRC section; and, along with increasing and decreasing the number of types of data in the measurement data section, the type of this data is stipulated by a transfer pattern section. By reducing the number of types of the data, the length of the data is shortened, thus ensuring the communication speed. Furthermore, the measurement times of the sensor unit (10) are accurately managed by the robot CPU (12), by transmitting time stamp data from the robot CPU (12), and by transmitting time stamp+time count data from the sensor unit (10).

### BACKGROUND OF THE INVENTION

1. Field of the Invention

The invention relates to a robot control system, and in particular to data communication between a main processor of a robot and sensor units.

2. Description of Related Art

Acceleration sensors and angular velocity sensors are used for attitude control of a mobile body of a robot or the like. If three orthogonal axes are set up, i.e. an X axis, a Y axis, and a Z axis, then the accelerations in these three axial directions are detected by three acceleration sensors, and the angular velocities around these three axes are detected by three angular velocity sensors. The angles around these axes, i.e. the attitude angles, are obtained by time integration of the outputs of the angular velocity sensors, and thereby a roll angle, a pitch angle, and a yaw angle are calculated.

In Japanese Patent Application Publication No. JP-A-2004-268730, a technique is disclosed for performing attitude control by using acceleration data and attitude data outputted from gyro sensors.

Furthermore, in Japanese Patent Application Publication No. JP-A-6-340149, it is disclosed to transmit and receive data consisting of groups of commands and parameters of variable length.

While the sensor data such as the attitude angle and the like which have been detected by the sensor unit are transmitted to a main processor (or to a host processor) which performs attitude control of the robot, and are used in feedback control, since the controllability of the robot is decreased when the control cycle becomes long along with increase in the amount of data, it is desirable to be able to enhance the controllability by, according to requirements, adjusting the amount of data which is transmitted and thereby ensuring the data communication speed.

Furthermore, if some data is missing due to a failure in communication or the like, the main processor is able to perform a predetermined missing procedure and to maintain the controllability of the robot, but it is necessary for the main processor to be reliably able to detect the very fact that data omission has occurred.

### DISCLOSURE OF THE INVENTION

It is an object of the invention to provide a robot control system, with which it is possible to ensure the responsiveness of robot control.

A robot control system according to a first aspect of the invention, comprises a main processor for a robot, and a sensor unit which transmits sensor output to the main processor. Between the main processor and the sensor unit, data is transmitted and received in a variable length data format.

With the first aspect of the invention, a fixed length data format is not used; rather, the controllability of the robot is ensured by transmitting and receiving the data in a variable length data format. In other words, by performing data transmission and reception while shortening the length of the data as appropriate, it is possible to enhance the communication speed, and thus to suppress control lag.

Thus, in concrete terms, the variable length data format includes a transfer size section, a command section, a transfer pattern section, and a data section; the amount of data transferred is stipulated by the transfer size section; the details of the destination for transfer are stipulated by the command section; and the types and the sequence of the data to be transferred are stipulated by the transfer pattern section. It is thus possible to shorten the length of the data by reducing the number of types of data to be transferred, and moreover, since the type and the sequence of the data to be transferred (from the point of view of the reception side, of the received data) are stipulated by the transfer pattern section, it is possible reliably to acquire the data which is required by the reception side even if the length of the data changes.

According to a second aspect of the invention, in the first aspect, data specifying a time instant timed by the main processor is included in the data which is transmitted from the main processor to the sensor unit, and, moreover, in that the data specifying a time instant, and data specifying an elapsed time timed by the sensor unit, are included in the data which is transmitted from the sensor unit to the main processor. By including data specifying a time instant and data specifying an elapsed time in the data which is transmitted from the sensor unit to the main processor, it is possible, in the main processor, to obtain time information about the data which has been received from the sensor unit, and it is possible simply and easily to detect omission of data from non-sequentiality of the times of the received data. Furthermore, even if a delay has occurred in the data which is sent from the sensor unit to the main processor, since the (data specifying the time instant+the data specifying the elapsed time) are included in the data which is transmitted from the sensor unit to the main processor, accordingly it is possible for the main processor to identify the time (the measurement time) of the data which has been transmitted from the sensor unit in an accurate manner. Moreover, since data specifying time instants is only generated by the main processor, there can be no occurrence of any so called synchronization problem, i.e., of any problem of an error between a time instant as measured by the main processor and a time instant as measured by the sensor unit.

Since, according to the invention, it is possible to increase and decrease the length of the data which is transmitted and received in an appropriate manner, accordingly it is possible to ensure the responsiveness of robot control.

Furthermore since, according to the second aspect of the invention, it is possible for the main processor to acquire time information in an accurate manner, it is possible to perform real time processing for the robot even if a time delay occurs in the transmission of data by the sensor units.

### BRIEF DESCRIPTION OF THE DRAWINGS

The foregoing and further objects, features and advantages of the invention will become apparent from the following description of example embodiments with reference to the accompanying drawings, wherein the same or corresponding portion are denoted by the same reference numerals and wherein:

FIG. 1 is a conceptual structural diagram of a robot control system according to an embodiment of the invention;

FIGS. 2A and 2B are a timing chart for data transmission and reception;

FIG. 3 is a data format diagram;

FIGS. 4A and 4B are a figure for explanation of variable length data;

FIG. 5 is a figure for explanation of a time stamp and a time count which are included in a measurement data section;

FIG. 6 is a figure showing an example of time stamps and time counts; and

FIGS. 7A and 7B are an explanatory figure showing time management for this robot control system.

### DETAILED DESCRIPTION OF THE PREFERRED EMBODIMENTS

In the following, an embodiment of the invention will be explained with reference to the drawings.

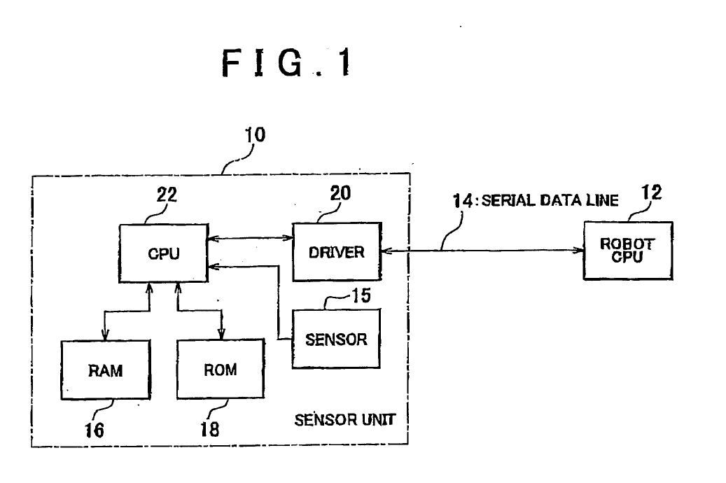

FIG. 1 is a conceptual structural diagram of a robot control system according to an embodiment of the invention. A sensor unit 10 and a robot CPU 12, which is a main processor (a host processor) of a robot, are provided, and this sensor unit 10 and robot CPU 12 are connected together by a serial data line 14, so as to be capable of serial communication with one another. It should be understood that the robot to which this sensor unit 10 and robot CPU 12 are installed may be of any desired type; it may be any of a robot which runs upon two wheels, a robot which runs upon four wheels, a robot which walks upon two legs, a flying robot, or the like.

The sensor unit 10 comprises a sensor 15 which is an acceleration sensor or an angular velocity sensor or the like, a RAM 16, a ROM 18, a driver 20, and a CPU 22.

The ROM 18 stores an OS (operating system) or a program in which is written execution processing for the sensor unit 10. In this program, there are included parameters which change over the type of the sensor output to be transmitted to the robot CPU 12 or a reset function, or which set the time constant of an internal filter or the like. The ROM 18 is a memory which can be rewritten, such as a flash ROM or the like.

The RAM 16 stores parameters which have been stored in the ROM 18. In other words, the parameters which are stored in the ROM 18 are read out and are written (i.e., are loaded) into the RAM 16, and predetermined processing is then performed by reading out the parameters which are written in the RAM 16. The CPU 22 writes these parameters which have been read out from the ROM 18 in a specified region of the RAM 16. In this embodiment, this specified region is termed the “first region”. For this first region, its start address (physical address) and its end address may be fixedly set in advance within the RAM 16; or, alternatively, they may be alterable.

According to the parameters which have been read out from the RAM 16, the CPU 22 selects, from among the various types of sensor output which have been inputted from the sensor 15, those of the sensor outputs which are set by the parameters, and transmits them to the robot CPU 12 via the driver 20. The driver 20 may be, for example, a RS-232C driver, but it is not limited thereto; it may alternatively be USB, RS422, IEEE1394, or the like. The CPU 22 transmits the sensor output data out to the serial line via the driver 20, but transmits this data only during a transmission period, which is a portion of a predetermined control period. The remainder of the predetermined control period is allocated as a reception period, during which the CPU 22 receives data which has been transmitted from the robot CPU 12 via the serial data line 14.

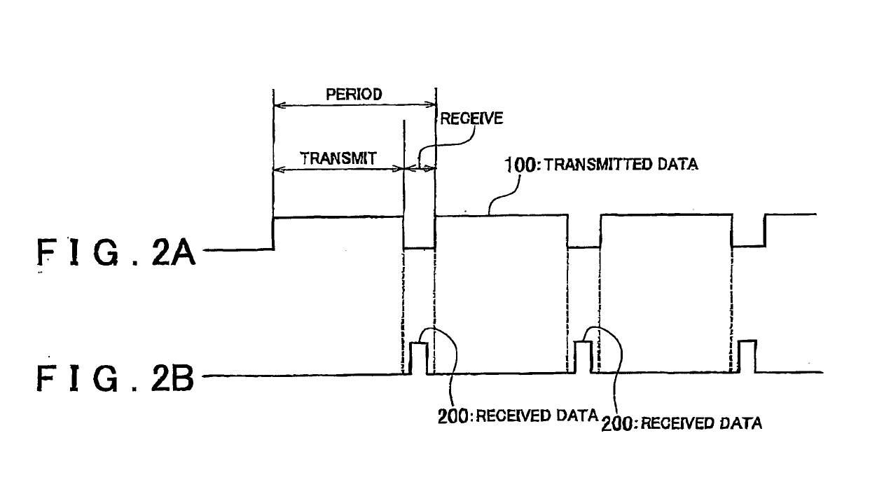

FIGS. 2A and 2B are a timing chart showing the serial communication which is performed between the CPU 22 of the sensor unit 10 and the CPU 12 of the robot. FIG. 2A is a timing chart during data transmission as seen from the CPU 22, while FIG. 2B is a timing chart during data reception as seen from the CPU 22.

In FIG. 2A, one control period is, for example, 10 msec, and this control period is time divided into a transmission period and a reception period. The CPU 22 transmits the sensor output serially from the sensor 15 to the robot CPU 12 during this transmission period. In the figure, the data which is transmitted from the CPU 22 during this transmission period is shown as being the transmitted data 100. This transmitted data 100 may be transmitted, for example, after having been encoded in BASE64. This BASE64 is a well known technique, and is a conversion method for transmitting binary data encoded as an ASCII file: it is performed by dividing the binary data up every 6 bits, and making each of these correspond to one of the 64 conventional ASCII symbols, consisting of alphabetic characters and other signs, by considering it as a 6-bit integer from 0 to 63. With such BASE64 encoding, while the amount of data is increased, there is the beneficial aspect that it is easy to read and write the data, since it is in a conventional format. Of course, other encoding methods or data compression methods could be used.

A single frame of transmitted data is constructed by appending a predetermined separation symbol (a delimiter) before and after the BASE64 encoded data. For delimiters, “(”, “<”, and “)” are used. “(” and “<” are used as starting delimiters of frames, and “)” is used as the ending delimiter; two possible examples of a single frame of transmitted data are:

one frame of transmitted data=(BASE64 encoded data)

one frame of transmitted data=<BASE64 encoded data)

Here, “(” is a delimiter which indicates that a command is included in the transmitted data, while “<” is a delimiter which indicates that sensor data which has been detected by the sensor unit 10 is included in the transmitted data. The former type of frame is termed a command type frame, while the latter type of frame is termed a measurement data type frame.

On the other hand, as shown in FIG. 2B, the remaining portion of the control period other than the transmission period is allocated as the reception period, and the robot CPU 12 transmits data to the serial data line 14 at this timing. The CPU 22 receives the data which has been transmitted from the robot CPU 12 at this timing. In the figure, the data which has been transmitted from the robot CPU 12 is shown as being the received data 200. When the CPU 22 receives data from the robot CPU 12 during this reception period, it stores this received data 200 in the RAM 16. The region in which the received data 200 is stored is a second region, which is different from the first region. The start address of the second region may be the next address after the end address of the first region, or may be separated therefrom by just a predetermined number of storage addresses. If the amount of data to be transmitted is large, then the robot CPU 12 divides this data into packets over a plurality of control periods, and transmits them in series. The CPU 22 receives this data in series, and stores it in the second region of the RAM 16. The parameters which are stored in the second region are used when changing the type or the like of the data transmitted from the sensor unit 10 to the robot CPU 12.

The Variable Length Data Format

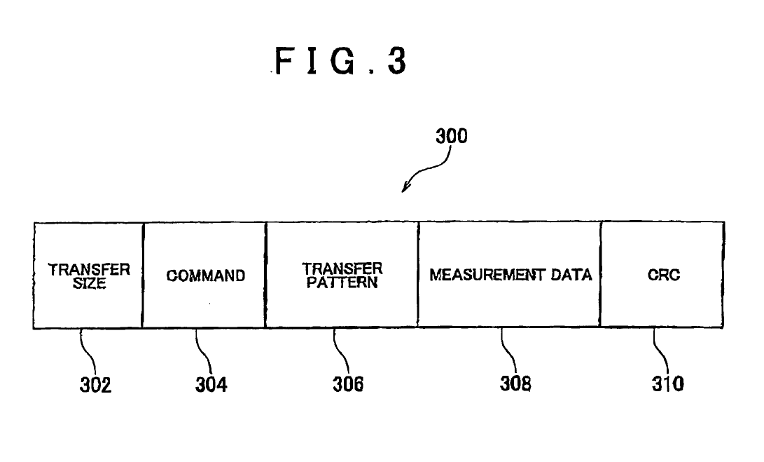

FIG. 3 shows a data format 300 which is used for data transmission between the sensor unit 10 and the robot CPU 12. This is a variable length data format, in which the amount of transmitted data can be adjusted by being increased and decreased.

The data format 300 consists of, in order, a transfer size section 302, a command section 304, a transfer pattern section 306, a measurement data section 308, and a CRC section 310.

The transfer size section 302 stipulates the total amount of data in one frame of transmitted data. This total amount of data may be expressed, for example, by two bytes.

The command section 304 stipulates details for execution by the destination for transfer. In particular, it stipulates the details of what must be executed by the sensor unit 10. This command is expressed as one byte. Examples of such commands are given below.

The “START” command is a command for starting measurement by the sensor unit 10. When it receives this “START” command, the CPU 22 transmits the sensor output from the sensor 15 to the robot CPU 12 for the designated period.

The “STOP” command is a command for stopping measurement by the sensor unit 10.

The “GET” command is a command for reading out the parameters which are stored in the first region or in the second region of the RAM 16.

The “SET” command is a command for writing new parameters into the second region of the RAM 16, and, upon this “SET” command, as described above, the CPU 22 stores the data which has been received from the robot CPU 12 in the second region of the RAM 16, and is able to change its characteristics by reading out and executing new parameters (update parameters) which are stored in this second region. In this embodiment of the invention, change of the type of the transmitted data or of the number of the transmitted data is included in change of characteristics of the sensor unit 10.

The “WRITE” command is a command for writing new parameters which are stored in the second region of the RAM 16 into the ROM 18. By doing this, the new parameters are preserved within the sensor unit 12 even after an interruption of the power supply.

The “RstTim” command is a command for resetting the time count of the sensor unit 10 to zero. The time count of the sensor unit 10 will be described hereinafter.

The transfer pattern section 306 stipulates the type of sensor data which is transmitted from the sensor unit 10 to the robot CPU 12. This transfer pattern may, for example, be expressed as 6 bytes. Although it is necessary to designate a transfer pattern for a measurement type frame, it is not necessary to designate one for a command type frame. An example of a transfer pattern is as follows:

Least significant bit (LSB): attitude angle (roll angle, pitch angle, yaw angle)

Bit 1: angular velocity

Bit 2: acceleration

Bit 3: tilt angle

Bit 4: acceleration after gravity compensation

Bit 5: speed

Bit 6: position

Bit 7: attitude matrix

Bit 8: attitude matrix

Bit 9: attitude matrix

Bit 10: attitude matrix

Bit 11: not used

Bit 12: unit temperature

Bit 13: substrate temperature

Bit 14: diagnosis

Bit 15: time count

When any one of these bits is “1”, data corresponding thereto is transmitted as the measurement data. For example, when bit 0 (LSB) is “1”, the attitude angle data from the sensor 15 is transmitted as the measurement data.

The measurement data section 308 is the sensor output among the outputs of the sensors 15 which was stipulated by the transfer pattern. For example, there are the possibilities attitude angle, angular velocity, temperature, time stamp, time count, unit name, and the like. Each of these sensor data has a fixed data format. In other words, the attitude angle, angular velocity, acceleration, temperature, and so on are floating point type data, while the time stamp and the time count are integer type data and the unit name is character type data.

The CRC section 310 stipulates CRC (Cyclic Redundancy Check) data. CRC is a well known technique, in which a transmitted data block which is the object of testing is considered as binary data, a fixed number of bits (16 bits or 32 bits) of test data are created by processing the block with a calculation equation such as a polynomial equation which generates binary data, this data for test which has thus been generated is transmitted attached to the actual data, and, on the reception side, the presence or absence of errors is tested for processing using the same polynomial equation.

Since, in this manner, the amount of data is stipulated by the transfer size section 302 at the head of the transmitted data format, and what type of sensor data is to be transmitted and what order it is to be transmitted in are stipulated by the transfer pattern section 306, accordingly it is possible to receive the various sensor data at the reception side in an accurate manner, even if the length of the data has been changed. Furthermore, since the specified delimiters are appended at the head of the frame and at its end, it is possible for the reception side simply and easily to determine the start and the end of the reception of the data, without being concerned with the length of the data. Moreover, when the robot CPU 12 (or the user) requests the sensor unit to change the type or the format of the data, even if, due to real time processing, the transmission of a transmitted frame in which the details of this change are reflected from the sensor unit 10 to the robot CPU 12 is delayed, since information relating to the data type and so on is written in within the data format 300, it is possible for the robot CPU 12 to perform input, without being conscious of the fact that a frame has been delayed.

In the following, an example will be explained in which a command which is to be transmitted from the robot CPU 12 to the sensor unit 10 for changing the sensor output is outputted, and the sensor unit changes the sensor output according to this command, and the length of the data which is transmitted from the sensor unit 10 to the robot CPU 12 changes.

It will be supposed that, among the outputs of the sensor 15, the CPU 22 of the sensor unit 10 is transmitting, during the transmission period, the attitude angle, the angular velocity, and the acceleration. In the data format 300 of FIG. 3, the robot CPU 12 sets a “SET” command in the command section 304, and then sets the data number (in the setting location) and the setting parameters, and transmits them to the sensor unit 10 in the reception period of FIG. 2. The CPU 22 of the sensor unit 10 interprets this “SET” command, and stores the parameters which are set in the measurement data section 308 in the second region of the RAM 16. The parameters which are already stored in the first region of the RAM 16 are the various bit values of the transfer pattern, and, since this is a pattern in which all of the attitude angle, the angular velocity, and the acceleration are transmitted, accordingly the second bit, the first bit, and the least significant bit are given by “111”. On the other hand, the new parameters which have been received from the robot CPU 12 and are stored in the second region of the RAM 16 are “100”. This is a pattern in which the acceleration is outputted, but the angular velocity and the attitude angle are not outputted. After having stored these parameters in the second region of the RAM 16, the CPU 22 transmits the sensor output from the sensor 15 to the robot CPU 12 in the data format 300 of FIG. 3, according to the parameters which have thus been stored in the second region. And, after having interpreted the “SET” command and stored the new parameters in the second region of the RAM 16, the CPU 22 changes over to the new parameters and transmits data from the next transmission timing. If the CPU 22 cannot allocate a job during execution of the calculation processing, or if there is no surplus time during communication by RS-232C or the like, then the changeover to the new parameters is reflected from the next transmitted frame. In this manner, the transfer pattern of the transfer pattern section 306 is changed over from “111” to “100, and the sensor outputs which are included in the measurement data section 308 are also changed over from (acceleration, angular velocity, attitude angle) to (acceleration). The delimiter “<” is appended at the head of the frame, and the delimiter “)” is appended at the end of the frame. The length of the data has become shorter, since the angular velocity and the attitude angle have been eliminated from the measurement data, so that the amount of data in one frame has also become less. The total amount of data is set by the transfer size section 302 at its head.

The robot CPU 12 determines upon one frame of data which has been received from the sensor unit 10 by detecting the head delimiter and the end delimiter of the data, determines the amount of data in the frame which has thus been received from its transfer size section 302, determines from the transfer pattern section 306 that only the acceleration has been transmitted, and acquires the acceleration which has been set in the measurement data section 308. The robot CPU 12 performs feedback control of the attitude of the robot according to this acceleration which has been received. Since the amount of data which has been transmitted is less (i.e., the length of the data is shorter), accordingly it is possible to enhance the speed of communication.

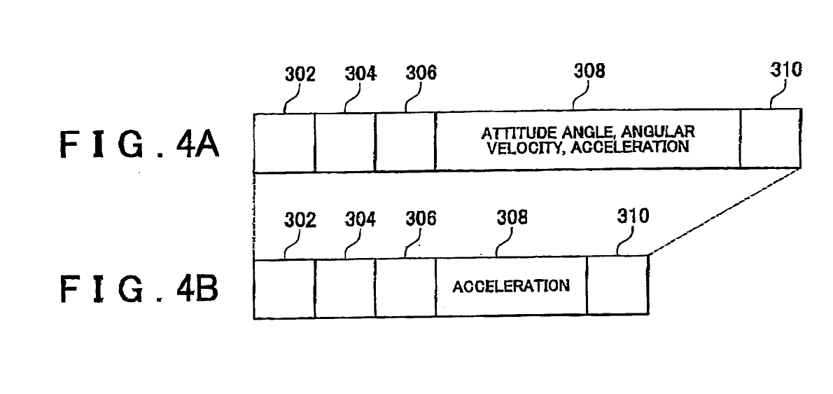

In FIGS. 4A and 4B, there are shown the data format before parameter change (in FIG. 4A) and the data format after parameter change (in FIG. 4B). A case is schematically shown in which the length of the data by the measurement data section 308 is made shorter.

Time Management With Time Stamps

On the other hand, when transmitting the sensor output from the sensor unit 10 to the robot CPU 12, sometimes it happens that data “jumps” occur in which data is missing. If control periods are taken as being T1, T2, and T3, then, during these periods, the sensor unit 10 transmits data without interruption, and sometimes it may happen that, while the robot CPU 12 receives the data for the periods T1 and T3, on the other hand the data for the period T2 is missing. It is necessary, when this type of loss of data has occurred, for the robot CPU 12 reliably to detect the occurrence of data loss, in order to perform loss processing. If it is not possible to detect such data loss, then attitude control is mistakenly performed based upon the sensor output during this error period; while, on the other hand, if it is possible to detect such loss of data, then it is possible to maintain attitude control by performing supplementary processing for the data which is missing.

Thus, in this embodiment of the invention, in addition to the variable length data format described above, “time stamp” data and “time count” data are appended to the measurement data section 308. This “time stamp” data is appended to the data which is transmitted from the robot CPU 12 to the sensor unit 10 at a periodic timing, or at any desired timing. The timing for appending this time stamp is set by the user. The robot CPU 12 incorporates an internal timer, and, when transmitting data, transmits data representing the reference time instant as a time stamp to the sensor unit 10.

The CPU 22 of the sensor unit 10 also incorporates an internal timer, and, when transmitting the sensor output of the sensor 15 to the robot CPU 12, transmits to the robot CPU 12 the time stamp which is included in the data from the robot CPU 12, in other words the data representing the reference time instant, and the elapsed time counted up by the timer. Each time the CPU 22 receives a time stamp from the robot CPU 12, it updates it and stores it in the RAM 16. Furthermore, the timer of the CPU 22 is reset when the power supply is turned ON, or when a “RtTim” command has been received from the robot CPU 12. Accordingly, the elapsed time gives the elapsed time from when the power supply was turned ON, or the elapsed time from when a “RtTim” command was received. By transmitting a time stamp along with transmitting the “RtTim” command from the robot CPU 12, it is ensured that the time count shows the elapsed time from the time instant shown by the time stamp, and thereby, by using the two items of information, i.e., the time stamp and the time count, the robot CPU 12 is able accurately to detect the time information about the data which has been received from the sensor unit 10.

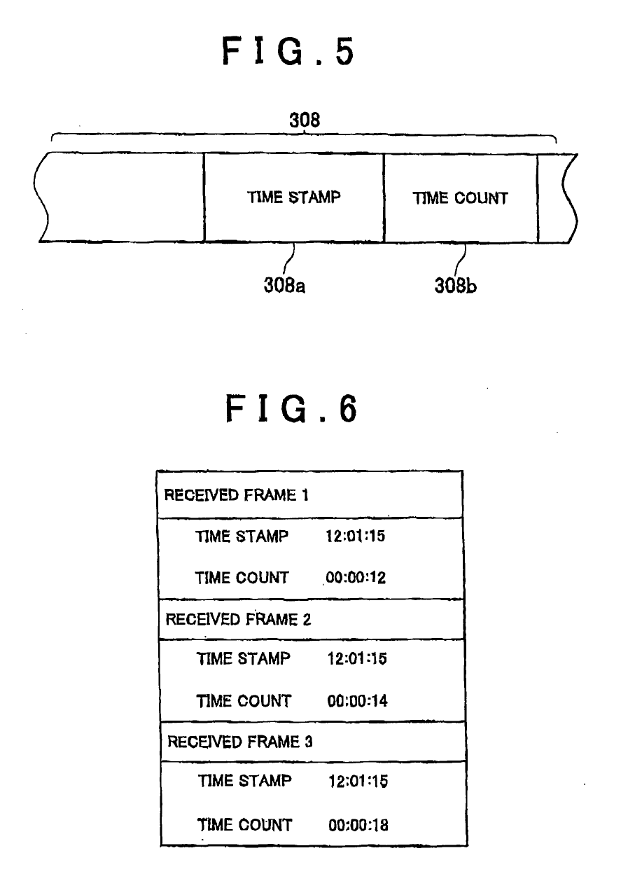

FIG. 5 schematically shows a portion of the measurement data section in the data format 300. The “time stamp” 308a is included in the data which is transmitted from the robot CPU 12 to the sensor unit 10, and is data specifying the reference time instant at which the robot CPU 12 performed measurement: for example, this may be 12:01:15 or the like. And the “time count” 308b is data specifying the elapsed time from when the sensor unit 10 performed measurement: for example, this may be 00:00:12. By detecting the time stamp 308a and the time counter 308b which are appended to the data which it has received from the sensor unit 10, the robot CPU 12 is able to identify the timing of the data which has been received from the sensor unit 10. The “time stamp” 308a may also be called a time label which is appended to the “time count” 308b. As shown in FIG. 6, the time stamps and the time counts for the frames 1, 2, and 3 which the robot CPU 12 has received in that order from the sensor unit 10 are supposed to be as follows:

<Received Frame 1>

Time stamp 12:01:15

Time count 00:00:12

<Received Frame 2>

Time stamp 12:01:15

Time count 00:00:14

<Received Frame 3>

Time stamp 12:01:15

Time count 00:00:18

The robot CPU 12 is able to detect that data between the received frame 2 and the received frame 3 is missing, from the difference between the time counts of the received frame 2 and the received frame 3.

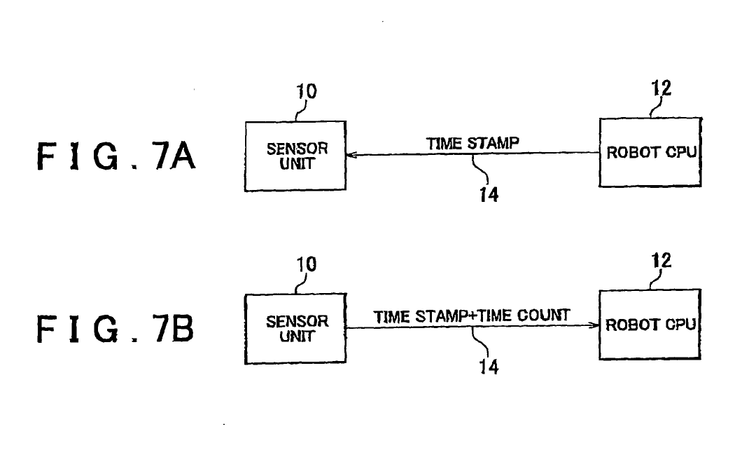

FIGS. 7A and 7B schematically show the time management between the sensor unit 10 an the robot CPU 12, in other words, the time management by dispatch and receipt of time data. First, in FIG. 7A, the robot CPU 12 transmits a time stamp at the time instant t1. The CPU 22 of the sensor unit 10 receives this time stamp, and stores this time stamp, which specifies the time instant t1, in the RAM 16. If a “RsTim” command was received along with the time stamp, then the timer is reset to zero by this command, and counting up is again performed from the time instant t1 of the time stamp. as shown in FIG. 7B, to the sensor output from the sensor 15, the CPU 22 appends a time stamp of the time instant t1 and the time count Δt which has been measured by the timer, and then transmits them to the robot CPU 12. The robot CPU 12 is able to identify the time instant at which the data was received as being t1+Δt. Accordingly, even if for example some time is needed for communication, so that a delay time has arisen in transmission from the sensor unit 10 to the robot CPU 12, since the robot CPU 12 can specify the time instant of the received frame, in other words the measurement time by the sensor unit 10, it can perform processing in real time. Furthermore, if the effective time instants at which data is successively received are respectively t1+Δt, t1+2·Δt, t1+3·Δt, then it is possible to detect that the data has been received without loss. On the other hand, if the effective time instants at which data is successively received are respectively t1+Δt, t1+2·Δt, t1+4·Δt, then, since the data is transmitted without interruption from the sensor unit 10 at a period which is determined in advance, it is possible to detect that the data item for t1+3·Δt is missing.

Although, in this embodiment, it would also be possible for a dedicated timer to be provided, not only in the robot CPU 12, but also in the sensor unit 10, and for the current time instant measured by this internal timer to be appended and transmitted when transmitting data from the sensor unit 10, it would be necessary for the timer in the sensor unit 10 and the timer in the robot CPU 12 to agree with one another accurately. Since, in this embodiment, the current time instant is not measured by the sensor unit 10, but only the time interval is measured and is transmitted together with the time stamp, accordingly it is not necessary to consider the question of the synchronization of two timers.

As explained in the above, with this embodiment of the invention, it becomes possible to provide smooth attitude control by:

(1) transmitting data without interruption from the sensor unit 10 to the robot CPU 12 at an interval which is determined in advance;

(2) arranging to make it possible to transmit data from the sensor unit 10 to the robot CPU 12 in a variable length data format, and to make it possible for the robot CPU 12 to be able reliably to receive and read in any type of data, even if it has been transmitted at any timing; and

(3) when data is transmitted from the sensor unit 10 to the robot CPU 12, arranging for measurement time data to be appended by the sensor unit 10 and to be transmitted to the robot CPU 12, so that problems of synchronization or of errors between two timers do not occur, and so that it is possible for the robot CPU 12 accurately to specify how much data this is.

Although, in this embodiment, the sensor unit 10 transmits data specifying a time stamp and a time count in the variable length data format 300 to the robot CPU 12, it would also be possible to apply this to any desired data format, including a fixed length data format.

Furthermore although, in the above described embodiment, one to one communication between the robot CPU 12 and the sensor unit 10 was shown by way of example, the invention should not be considered as being limited thereto. It would also be acceptable to connect a large number of devices to a communication line such as USB, IEEE1394, Ethernet (a registered trademark), or the like. In concrete terms, this is a situation in which a large number of types of sensors or actuators are present, and moreover a large number of robot CPUs 12 are present, all being connected to the communication network. With this type of many-to-many system, in order to ensure its real time nature, not only is it not enough for the communication speed to be sufficiently high, but also it becomes very important for it to be possible to perform decoding of the data in its data units, and for the necessary time instant information for performing time instant compensation to be included in the data. In other words, upon a communication network, devices of high grade whose communication speed is fast, devices of low grade whose communication speed is slow, devices for which, although they are of high grade and have high communication speed, the amount of data is extremely large, so that they take considerable time for communication, and the like are mixed together, and, since communication between these is performed randomly, it is not possible for all of the devices to operate accurately in real time, and in practice it is necessary to match their timing within a sufficient time width. In practice, this sufficient time width depends upon the system, but generally it is around 1 ms to 100 ms. Thus, in practice, in order to ensure real time control, it becomes key for self decoding capability and time instant calculation function to be provided. It should be understood that, although it is necessary to identify itself, or based upon from which device the command is from, this can be managed by the header portion. Furthermore, although in this embodiment BASE64 is used as described above, since BASE64 is a conventional format, there is also the beneficial aspect that it is possible for each of a plurality of devices, by reading the data size and header, to determine in a simple and easy manner whether or not this is data which it itself requires, even without reading the contents (the measurement data).

In the following, the case of connecting a robot CPU 12 and a sensor unit 10 to a network will be explained in more concrete terms. It should be understood that it is supposed that, to each of these, there is appended a symbol (a sensor name or a sensor number or the like) which mutually identifies each of the sensors upon the network, or a symbol (a processor name or a processor number or the like) which identifies the CPU, and these are included in the transmitted data.

When a Plurality of Sensors are Present Upon the Network

Since, in the data from a sensor, there is included the symbol which identifies the sensor, accordingly the robot CPU is able to identify the sensor of this specification from among the plurality of sensors. Furthermore, the robot CPU is able to transmit a command to a specified sensor by using this symbol which identifies the sensor.

When a Plurality of CPUs are Present Upon the Network

Since, in the data from a sensor, there is included a symbol which identifies a specified CPU from among the plurality of CPUs, accordingly it is possible for the plurality of CPUs of the robot to identify the specified CPU which is to use the data of this sensor. Furthermore, since the specified CPU from among the plurality of CPUs of the robot includes the symbol which identifies itself among the data which it transmits, accordingly it is possible to transmit a command to the sensor while identifying the specified CPU.

When a Plurality of Sensors and a Plurality of CPUs are Present Upon the Network

Since, in the data from a sensor, there are included a symbol which identifies that sensor and also a symbol which identifies a CPU, accordingly it is possible for the plurality of CPUs of the robot and the plurality of sensors mutually to identify the combination of that sensor and that CPU. Furthermore since the specified CPU, among the plurality of CPUs of the robot, performs transmission of data while including a symbol which identifies a specified sensor and a symbol which identifies that CPU, accordingly it is possible to transmit a command to the specified sensor while identifying the specified CPU.

The Time Stamps and the Time Counts When a Plurality of Sensors and a Plurality of CPUs are Present Upon the Network

The time count is counted up in an integrated manner by a time counter which is intrinsic to each sensor. As for the time stamp, each CPU has its own intrinsic time stamp, and the sensors and, by a predetermined combination of sensors, the sensors and the CPUs share a time stamp in common. Due to this, the time instants which are recognized and managed by the plurality of sensors are synchronized, and moreover it is possible to control the robot in real time even this synchronization is not maintained. The sensors can operate with simple time counters (clock counters or the like), so that these functions can be implemented at low cost.

With this method, it is possible to synchronize the time instants of the plurality of CPUs, and moreover it is possible to control the robot in real time, even if this synchronization is not maintained. Due to this, it is possible to make the CPU more compact and to implement it at lower cost. Furthermore since, even if the system is expanded or additional devices are plugged in, it is not necessary for the time instants of the added CPUs or sensors to be synchronized, accordingly additions to the system, or reductions thereof, are simple and easy. Generally, it is difficult to synchronize the time instants of a plurality of sensors or CPUs, and to keep them synchronized, and this can entail increase in the size of the system, increase of its cost, and delays in its operation. Since normally, in a simple clock counter, the counting is performed by a clock of low grade such as a quartz crystal oscillator, accordingly it is difficult accurately to match the clock periods and the clock timings of the plurality of sensors and the plurality of CPUs, so that it is not possible in practice to synchronize the time instants of a plurality of sensors and a plurality of CPUs. Since what is necessary for real time control of a robot or the like is to ascertain a synchronized time instant for a predetermined CPU and a predetermined sensor, accordingly it is possible to implement equivalent behavior to synchronization of the time instant, by having an intrinsic time stamp in common. Furthermore, by updating the time stamp at a predetermined long period, it becomes possible to eliminate errors of integration due to counting by a clock such as a quartz crystal oscillator of low grade, and thus long term time instant management becomes possible in practice. Thus, by the plurality of CPUs having the same time stamp in common, it is also possible simply and easily to implement equivalent matching of their mutual time instant.

1. A robot control system, comprising:
a main processor for a robot; and
a sensor unit that transmits sensor output to the main processor, wherein:
between the main processor and the sensor unit, data is transmitted and received in a variable length data format;
the variable length data format includes a transfer size section, a command section, a transfer pattern section, and a data section;
the transfer size section stipulates an amount of data transferred;
the command section stipulates details of the destination for transfer; and
the transfer pattern section stipulates types and a sequence of the data to be transferred.

2. The robot control system according to claim 1, wherein:
the main processor sets, as the transfer pattern, parameters so as to reduce the number of types of data to be transferred, and transmits the parameters to the sensor unit; and
the sensor unit sets the transfer size and the transfer pattern of the variable length data format according to the parameters, and transmits a reduced number of types of data to the main processor.

3. The robot control system according to claim 1, wherein:
data specifying a time instant timed by the main processor is included in the data which is transmitted from the main processor to the sensor unit; and
the data specifying a time instant, and data specifying an elapsed time timed by the sensor unit, are included in the data which is transmitted from the sensor unit to the main processor.

4. The robot control system according to claim 3, wherein the elapsed time is counted up by a time counter which is intrinsic to each sensor.

5. The robot control system according to claim 1, wherein the sensor unit transmits date to the main processor during a transmission period, which is a portion of a predetermined control period, and receives data from the main processor during the remaining period of the predetermined control period.

6. The robot control system according to claim 1, wherein the sensor output includes at least one of attitude angle, angular velocity, acceleration, temperature, time stamp, time count and unit name.

7. The robot control system according to claim 1, wherein the sensor output includes at least one of a symbol which identifies a sensor and also a symbol which identifies a CPU.
